(19) United States
(12) Patent Application Publication
(10) Pub. No.: US 2020/0160457 A1
(43) Pub. Date: May 21, 2020

(54) Method For Bank-Based Tax System

(71) Applicant: Kevin B. Collins, Lansing, MI (US)

(72) Inventor: Kevin B. Collins, Lansing, MI (US)

(21) Appl. No.: 16/686,843

(22) Filed: Nov. 18, 2019

Related U.S. Application Data
(60) Provisional application No. 62/769,250, filed on Nov. 19, 2018.

(51) Int. Cl. G06Q 40/00; G06Q 40/02

(52) U.S. Cl. CPC G06Q 40/123; G06Q 40/02; G06Q 40/10

(57) ABSTRACT

A system and/or method (collectively referred to herein as “system”) for individuals, employees, independent contractors, business owners, and/or any other applicable taxpayers (collectively referred to herein as “taxpayer” or “taxpayers”) to have income tax withheld and submitted to federal, state and local tax authorities throughout the tax year, and to file taxes at the end of the year, via a bank account designed for this purpose (referred to herein as an income tax account or ITA).

### I. CROSS-REFERENCE TO RELATED APPLICATION

This patent application is a non-provisional application claiming priority from U.S. Provisional Patent Application Ser. No. 62/769,250, entitled Method For Bank-Based Tax System, filed on Nov. 19, 2018.

### II. FIELD OF THE INVENTION

The present invention relates to a system and/or method for creating a special income tax account and utilizing an independent party or bank for streamlining the flow and accuracy of information and money to and from this income tax account resulting in improvements in income tax reporting to applicable taxing authorities.

### III. DESCRIPTION OF THE PRIOR ART

Under the prior art system, for example, employers periodically withhold and submit estimated tax payments to tax authorities on behalf of employees throughout the tax year and give Forms W2 to employees at the end of the tax year. Independent contractors and business owners, on the other hand, are responsible for submitting their own estimated taxes on a quarterly basis throughout the tax year, and then receive Forms 1099 from customers at the end of the tax year. The taxpayer is then responsible for combining personal information, W2 (or 1099) information, information from forms affecting credits and deductions (such as Form 1098), and information from forms reporting other income (such as Schedule K1, other, etc. . . . ) at the end of the tax year in order to calculate, or pay someone to calculate, actual tax and generate a Form 1040 to be submitted to tax authorities.

Applicant's unique system, however, accomplishes all of these steps at one place (the bank ITA) and creates the Form 1040 for the taxpayer to submit to tax authorities. Applicant's system significantly reduces compliance and administrative cost(s) for taxpayers, employers and customers, and would help to ensure a more consistent application of the tax code across taxpayers. Tax authorities could also use Applicant's system to capture large amounts of tax revenue that is lost under our current tax system.

Thus, there is a need and there has never been disclosed Applicant's unique method for bank-based tax system.

### IV. SUMMARY OF THE INVENTION

The present invention is a system and/or method (collectively referred to herein as “system”) for individuals, employees, independent contractors, business owners, and/or any other applicable taxpayers (collectively referred to herein as “taxpayer” or “taxpayers”) to have income tax withheld and submitted to federal, state and local tax authorities throughout the tax year, and to file taxes at the end of the year, via a bank account designed for this purpose (referred to herein as an income tax account or ITA).

### V. BRIEF DESCRIPTION OF THE DRAWINGS

The Description of the Preferred Embodiment will be better understood with reference to the following figures:

FIG. 1 is a schematic diagram of the basic operation for establishing and setting up an income tax account.

FIG. 2 is a schematic diagram of the basic operation for operating and process for using the income tax account throughout the tax year.

FIG. 3 is a schematic diagram of the basic operation for operating and process for using the income tax account at the end of the tax year.

FIG. 4 is a diagram illustrating all of the taxpayer's tax information used to establish and set up the income tax account.

FIG. 5 is a representative example of a Pay Statement of the income tax account provided by the bank to the taxpayer.

### VI. DETAILED DESCRIPTION OF THE PREFERRED EMBODIMENT

Applicant's system consists of several stages: establishing or setting up the income tax account (ITA), operating and process for using the ITA throughout the tax year, and operating and process for using the ITA at the end of the tax year, each of which are more fully described below.

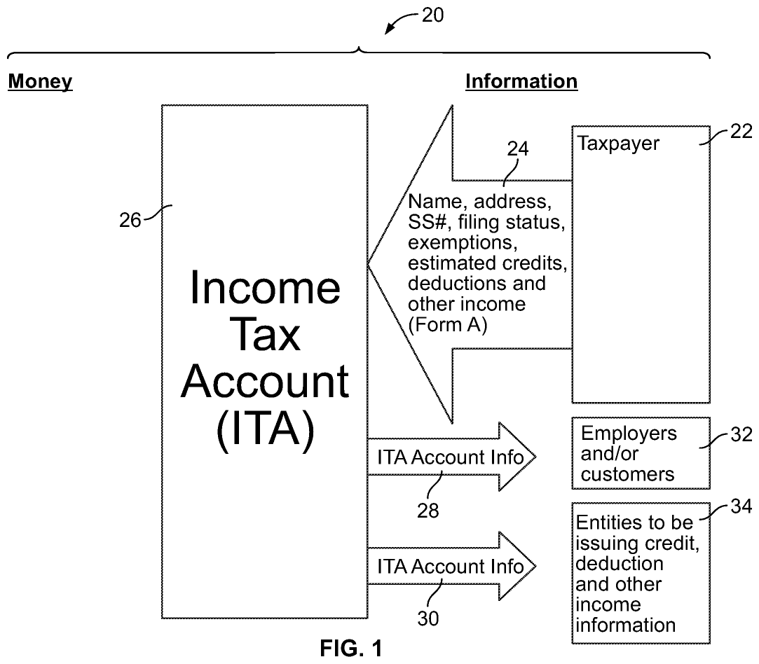

Turning first to FIG. 1, there is illustrated a schematic diagram of the basic operation for establishing and setting up the ITA (“setup 20”).

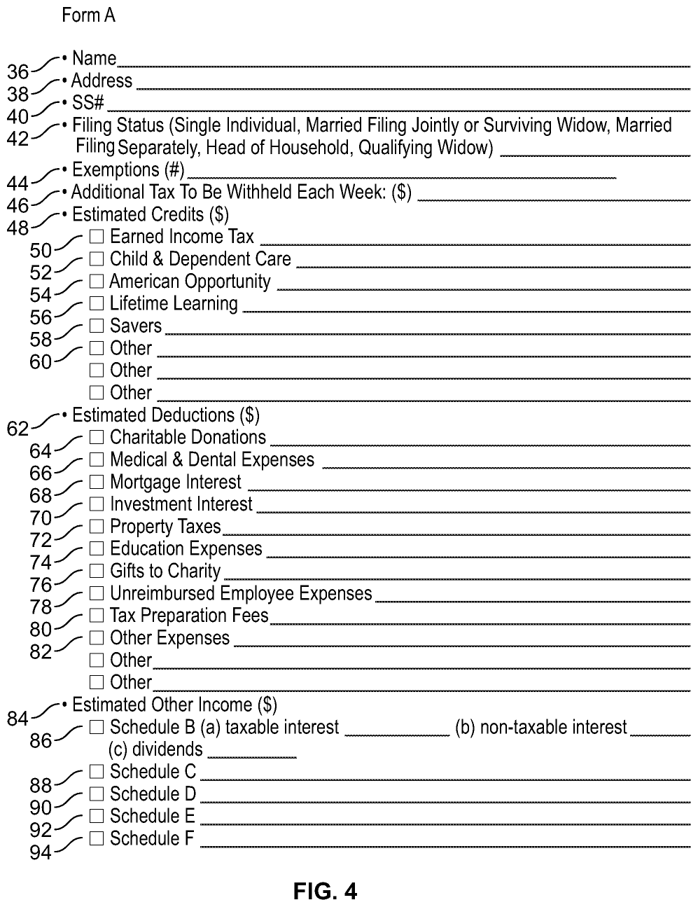

In Step 22, a taxpayer determines and creates all of its or their desired tax information. In the preferred embodiment, as illustrated in Form A of FIG. 4, all of this tax information includes but is not limited to the taxpayer's name 36; address 38; social security number 40; filing status 42 such as, for example, single individual, married filing jointly or surviving widow, married filing separately, head of household, or qualifying widow; number of exemptions 44; additional tax to be withheld each week 46; estimated credits 48, which include but are not limited to earned income tax credit 50, child and dependent care tax credit 52, American opportunity credit 54, lifetime learning credit 56, saver credit 58, and any other applicable credits 60; estimated deductions 62, which include but are not limited to charitable deductions 64, medical and dental expense deductions 66, mortgage interest deduction 68, investment interest deduction 70, property tax deduction 72, education expense deduction 74, gifts of charity deduction 76, unreimbursed employee expense deduction 78, tax preparation fee deduction 80, and any other applicable expense deductions 82; estimated other income 84, which include but are not limited to Schedule B income 86 consisting of interest and ordinary dividend income such as, for example, taxable interest, non-taxable interest, or dividends, Schedule C income 88 consisting of any income or loss from a business that taxpayer operated or profession practiced as a sole proprietor, Schedule D income 90 consisting of any income from any capital gains and/or losses, Schedule E income 92 consisting of income or loss from rental real estate, royalties, partnerships, S corporations, estates, trusts, and residual interests in real estate mortgage investment conduits (REMICs), and Schedule F income 94 consisting of profit and/or loss from farming. Preferably, the Schedules B through F relate or correspond to the Internal Revenue Service (IRS) schedules that would typically accompany the Form 1040 reporting. Collectively all of this tax information is referred to herein as “Tax Information.” This Tax Information can be updated at any time by the taxpayer. If the taxpayer desires to continue the process for establishing and setting up the ITA, proceed to Step 24.

In Step 24, the taxpayer supplies the bank with all of this Tax Information. In the preferred embodiment, this Tax Information is transferred electronically to the bank. Proceed to Step 26.

In Step 26, upon receipt of the Tax Information, the bank creates an Income Tax Account (ITA) for this taxpayer and based on this Tax Information criteria. Where applicable, proceed to Step 28 and/or Step 30.

In Step 28, if the taxpayer receives income from employer(s) and/or customer(s), the taxpayer proceeds to provide the ITA account information to each of their employer(s) and/or customer(s). Preferably, the ITA account information comprises at least the bank name, routing number and account number (collectively referred to herein as “ITA Account Information”). Proceed to Step 32.

In Step 32, the taxpayer instructs each of their employer(s) and/or customer(s) to not withhold any income taxes or the taxpayer's share of Federal Insurance Contributions Act (FICA) taxes from the amount paid to the taxpayer. Each of the employer(s) and/or customer(s) would continue to withhold health insurance premiums, as applicable, any employer administered retirement savings account contributions such as, for example, 401k contributions, applicable garnishments, and any other desired or required withholdings other than income tax. Alternatively, should any of the employer(s) and/or customer(s) withhold any amounts due to the relevant authorities, the employer(s) and/or customer(s) would be required to transmit or submit the amount withheld to the appropriate authorities; and any amounts withheld would be reported to the ITA. The employer(s) and/or customer(s) would then make the payment and/or deposit the taxpayer's income directly to the bank for deposit into the ITA (collectively referred to herein as “Income Deposit”) using an automated clearing house (ACH) direct deposit, electronic funds transfer (EFT), wire transfer, or any other means known to one skilled in the art.

In Step 30, if the taxpayer has entities that will be issuing information regarding credits and deductions such as, for example, from IRS Form 1098, and/or information regarding other of the taxpayer's income such as, for example, as set forth on the IRS Schedule K1, the taxpayer proceeds to provide the ITA Account Information to each of these entities. Proceed to Step 34.

In Step 34, each of the entities that will be issuing information regarding credits and deductions such as, for example, from IRS Form 1098, and/or information regarding other of the taxpayer's income such as, for example, as set forth on the IRS Schedule K1, shall then receive all of the ITA Account Information.

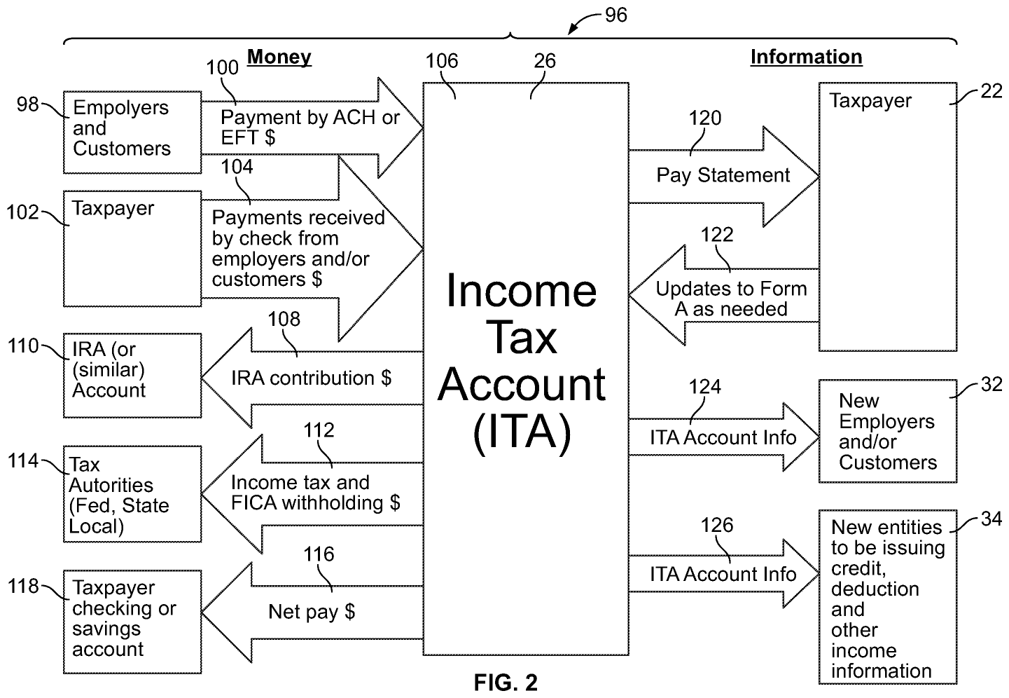

Turning to FIG. 2, there is illustrated a schematic diagram of the basic operation for operating and process for using the income tax account (ITA) throughout the tax year (“Yearly Process 96”). This Yearly Process 96 is described in more detail in Steps 98 through 126 below.

In Step 98 and Step 100, if the taxpayer receives income from employer(s) and/or customer(s), these employer(s) and/or customer(s) would then make the payment and/or deposit the taxpayer's Income Deposit directly to the bank for deposit into the ITA using an automated clearing house (ACH) direct deposit, electronic funds transfer (EFT), wire transfer, or any other means known to one skilled in the art. Proceed to Steps 102 and 104.

In Step 102 and Step 104, if the taxpayer receives any payments by check from employer(s) and/or customer(s), the taxpayer would then deposit any of said received payments into the ITA (collectively referred to herein as “Taxpayer Deposits”). Proceed to Step 106.

In Step 106, the bank, based on the Income Deposits and Taxpayer Deposits received (collectively referred to herein as “Total Deposits”) and Tax Information provided by taxpayer, proceeds to determine (i) the amount of estimated income tax due which includes at least the federal income tax, state income tax, local income tax (“Tax Authority Tax Due”); (ii) the amount of the taxpayer's share of FICA tax due on Income Deposits received from employer(s) and/or customer(s) (“FICA Tax Due”); (iii) the amount of any applicable health insurance premiums (“Health Insurance Tax Due”); (iv) the amount of any taxpayer administered retirement savings account contributions such as, for example, an individual retirement account (IRA), etc. . . . (“Retirement Amount Due”); and (v) the amount of any applicable garnishments and any other desired or required withholdings other than income tax (“Garnishment and Other Amount Due”). The total amount of the tax determined from (i) through (v) above is collectively referred to herein as “Income Tax Due.” Proceeds to Steps 108 through 118.

In Step 108 and Step 110, having determined the Retirement Amount Due, the bank transfers or sends the Retirement Amount Due to all applicable designated retirement savings accounts.

In Step 112 and Step 114, having determined the Income Tax Due, the bank transfers or sends the Income Tax Due to all applicable tax authorities or parties at required intervals. When necessary or required, the bank shall also send the Garnishment and Other Amount Due to the appropriate authorities and/or parties.

In Step 116 and Step 118, after deducting the total Income Tax Due from the Total Deposits, the bank transfers or sends the remaining amount to the taxpayer. In the preferred embodiment, this transfer is accomplished using an automated clearing house (ACH) direct deposit, electronic funds transfer (EFT), wire transfer, check or any other means known to one skilled in the art into the taxpayer's desired account (e.g., checking or savings account). Proceed to Step 120.

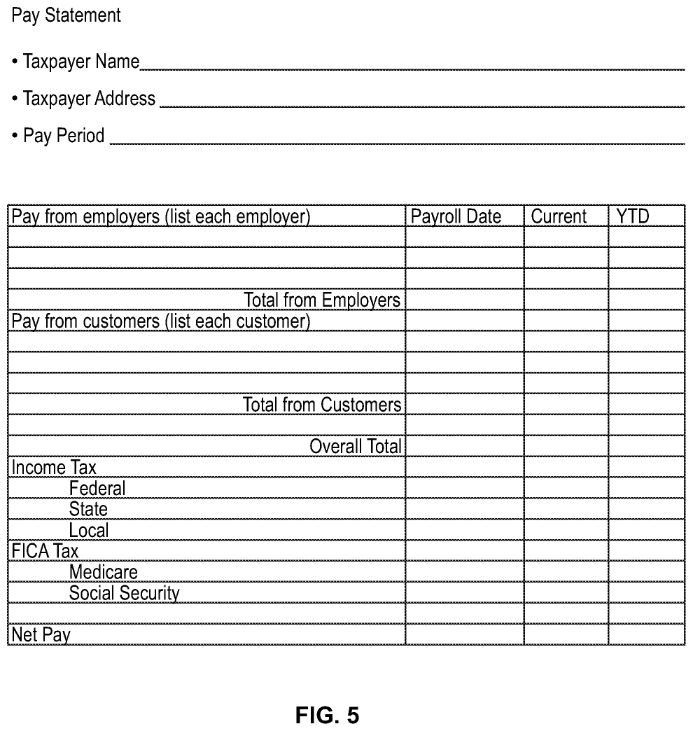

In Step 120, each week or other desired or required time interval, the bank provides the taxpayer a statement of the ITA and, in particular, an itemization of all of the money received and disbursed through the ITA (collectively referred to herein as “Pay Statement”). In the preferred embodiment, a representative example of the Pay Statement is illustrated in FIG. 5. Additionally, although the Pay Statement, as illustrated in FIG. 5, in its current form, does not list Health Insurance Tax, Retirement Amount Due, or Garnishment and Other Amount Due in the form's list of deductions, it is possible these amounts could likewise be included in the Pay Statement an alternate preferred embodiment.

Should the taxpayer determine that any information is needed or required to be updated, the taxpayer proceeds with Steps 122 through 126.

In Step 122, if the taxpayer determines that there are any updates to the Tax Information, the taxpayer supplies the bank with all of this updated Tax Information.

In Step 124, if the taxpayer determines that it is or will be receiving income from any additional employer(s) and/or customer(s), the taxpayer proceeds to provide the ITA account updated information to each of these additional employer(s) and/or customer(s).

In Step 126, if the taxpayer determines that there are any additional entities that will be issuing information regarding credits and/or deductions, the taxpayer proceeds to provide the ITA account updated information to each of these additional entities.

This Yearly Process 96 and Steps 98 through 126 continue to repeat throughout the year. By year's end, the bank can then determine (i) the total yearly Income Deposits and Taxpayer Deposits throughout the year (collectively referred to herein as “Total Yearly Deposits”), (ii) the total amount of Tax Authority Tax Due that was paid throughout the year (collectively referred to herein as “Yearly Tax Authority Tax Paid”); (iii) the total yearly amount of FICA Tax Due that was paid throughout the year (collectively referred to herein as “Yearly FICA Tax Paid”); (iv) the total amount of Health Insurance Tax Due that was paid throughout the year (collectively referred to herein as “Yearly Health Insurance Tax Paid”); (v) the total amount of Retirement Amount Due that was paid throughout the year (collectively referred to herein as “Yearly Retirement Amount Paid”); and (vi) the total amount of Garnishment and Other Amounts Due that was paid throughout the year (collectively referred to herein as “Yearly Garnishment and Other Amount Paid”). The total amount of the tax determined from (ii) through (vi) above is collectively referred to herein as “Total Yearly Amount Deductions Paid.”

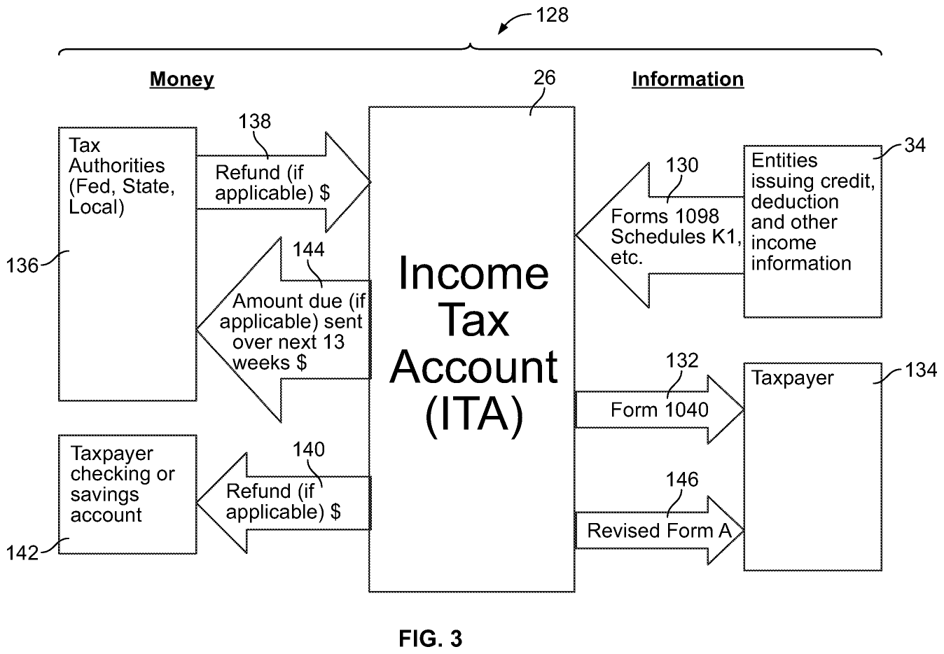

Turning to FIG. 3, there is illustrated a schematic diagram of the basic operation for operating and process for using the income tax account at the end of the tax year (“End of Year Process 128”). This End of Year Process 128 is described in more detail in Steps 130 through 146 below.

In Step 130, for any entities that will be issuing information regarding credits and/or deductions such as, for example, from IRS Form 1098, and/or information regarding other of the taxpayer's income such as, for example, as set forth on the IRS Schedule K1, each entity would then provide this Income Adjustments Information for the taxpayer directly to the bank administering the ITA.

In Step 132 and Step 134, based on the Total Yearly Deposits and each of the amounts that make up the Total Yearly Amount Deductions Paid, and based on information received from entities issuing information regarding credits and deductions, such as IRS Form 1098 or IRS Schedule K-1, the bank determines the actual tax for the year, creates the IRS Form 1040, and then sends this IRS form 1040 to the taxpayer for review, which once approved by the taxpayer, is then submitted to the applicable taxing authorities.

In Step 136 and 138, if, based on results of the completed IRS Form 1040, the taxpayer is owed a tax refund (“Tax Refund”), the applicable tax authorities transfer or send this Tax Refund amount to the taxpayer's ITA. Proceed to Step 140 and 142.

In Step 140 and Step 142, upon receipt of the Tax Refund amount from the applicable tax authorities, the bank then transfers or sends this Tax Refund amount to the taxpayer. As described above, preferably this transfer is again accomplished using an automated clearing house (ACH) direct deposit, electronic funds transfer (EFT), wire transfer, check or any other means known to one skilled in the art into the taxpayer's desired account (e.g., checking or savings account).

In Step 144, if, based on results of the completed IRS Form 1040, the taxpayer owes additional tax (“Additional Tax Due”), this Additional Tax Due amount is divided into thirteen (13) equal payment amounts and this separately divided amount is transferred or sent by the bank from the taxpayer's ITA to the applicable tax authorities over each of the subsequent or following thirteen (13) weeks along with the regular tax payments from taxpayer's ITA (i.e., thereby still meeting the traditional April 15 deadline for filing returns and paying amount due).

Additionally, the bank may apply this same process in Steps 132 through Step 144 with respect to the taxpayer's state, local, and any other applicable tax authorities.

In Step 146, based on the Total Yearly Deposits and each of the amounts that make up the Total Yearly Amount Deductions Paid, and based on information received from entities issuing information regarding credits and deductions, such as IRS Form 1098 or IRS Schedule K-1, the bank proceeds to update and/or revise the Tax Information, as set forth in Form A of FIG. 4, and sends this revised Tax Information to the taxpayer for review. If taxpayer, upon review, makes no changes, the revised Tax Information is saved in taxpayer's ITA and this revised Tax Information, or as otherwise updated by the taxpayer at any time during the year, is used as the basis for the entire process, as described above for the Yearly Process 96, for the next year.

Based on the detailed method for using Applicant's system above, Applicant's unique method for bank-based tax system provides many benefits and advantages which include without limitation:

Reduced Taxpayer Compliance Costs

The IRS's Taxpayer Advocate Service reports that, under the prior art system, American taxpayers spend billions of dollars and hours each year trying to comply with the requirements of the tax code. Using Applicant's new system described above, taxpayer withholding and filing activities are integrated in one, created to be mostly automated, account, saving the taxpayer most of the time and expense currently associated with income tax compliance. Since Applicant's system is designed to be mostly automated, the cost of administering these accounts would be relatively small and could come from a number of sources, including interest earned on account balances, savings to taxpayers from reduced compliance costs, and increased tax revenue to the government (see below).

More Equal Application of the Tax Code

Under the prior art system, those with the knowledge and resources to take advantage of the tax code's complexities fare better than others. For example, the IRS reports the Earned Income Tax Credit (EITC) goes unclaimed by about 20 percent of those eligible to receive it. By using Applicant's new system described above, the EITC and other credits and deductions would be applied more equally among taxpayers.

Increased Tax Revenues

According to the IRS, over $300 billion in income taxes go unpaid in this country each year because the prior art system largely relies on taxpayers to report their own income and calculate their own taxes. Although the IRS is able to verify individuals' income reported to it by employers and customers on forms W2 and 1099, that accounts for only a portion of total income earned. To reduce tax evasion, the IRS audits taxpayer returns, but this audit process is so labor intensive and costly that the IRS is only able to audit less than one percent (1%) of taxpayer returns, resulting in trillions of dollars of unreported and untaxed income each year. Using Applicant's new system, however, policy makers could require employers, contractors and business owners to deposit taxable income payments to bank ITAs for tax withholding and payment, and require banks to report deposits to non ITA accounts that appear to be attempts to evade taxation. This would significantly reduce unreported income and increase tax revenues.

Thus, there has been provided Applicant's unique method for bank-based tax system. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within spirit and scope of appended claims.

What is claimed is:

1. A method for bank-based tax system, comprising the steps of:
creating a list of tax information and defining a set of tax criteria;
completing the set of tax criteria for a taxpayer and defining a taxpayer baseline tax information;
creating an income tax account for the taxpayer;
collecting the taxpayer baseline tax information;
collecting income deposits comprising the following steps:
(a) defining a first entity that owes money to the taxpayer and defining a first income contribution;
(b) providing that the first entity deposits the first income contribution into the income tax account;
analyzing the first income contribution with the taxpayer baseline tax information;
creating taxes due for the taxpayer comprising the following steps:
(c) determining the amount of an income tax due for the taxpayer;
(d) determining the amount of a plurality of other taxes due for the taxpayer;
paying the income tax due for the taxpayer and the amount of the plurality of other taxes due for the taxpayer to the appropriate authorities; and
paying any net income remaining in the income tax account to the taxpayer.

2. The method of claim 1 and further comprising the step of selecting the first entity that owes money to the taxpayer from the group consisting of an employer of the taxpayer, and a customer of the taxpayer.

3. The method of claim 1 and further comprising the step of defining a second entity that owes money to the taxpayer and defining a second income contribution.

4. The method of claim 3 and further comprising the step of providing that the taxpayer deposits the second income contribution into the income tax account.

5. The method of claim 4 and further comprising the step of selecting the second entity that owes money to the taxpayer from the group consisting of an employer of the taxpayer and a customer of the taxpayer.

6. The method of claim 5 and further comprising the step of defining the second income contribution as money provided directly from the second entity to the taxpayer.

7. The method of claim 1 and further comprising the step of selecting the plurality of other taxes due for the taxpayer from the group consisting of a taxpayer's share of the Federal Insurance Contributions Act tax, a taxpayer's administered retirement savings account contribution, and any other required tax withholding.

8. The method of claim 1 and further comprising the step of selecting the appropriate authorities from the group consisting of a retirement savings account, a federal taxing authority, a state taxing authority, a local taxing authority, and any other taxing authority.

9. The method of claim 1 and further comprising the step of providing the taxpayer with an account pay statement.

10. A method for bank-based tax system, comprising the steps of:
creating a list of tax information and defining a set of tax criteria;
completing the set of tax criteria for a taxpayer and defining a taxpayer baseline tax information;
creating an income tax account for the taxpayer;
collecting income deposits comprising the following steps:
(a) defining a first entity that owes money to the taxpayer and defining a first income contribution;
(b) providing that the first entity deposits the first income contribution into the income tax account;
(c) defining a second entity that owes money to the taxpayer and defining a second income contribution;
(d) providing that the taxpayer deposits the second income contribution into the income tax account;
analyzing the first income contribution and the second income contribution with the taxpayer baseline tax information;
creating taxes due for the taxpayer comprising the following steps:
(e) determining the amount of an income tax due for the taxpayer;
(f) determining the amount of a plurality of other taxes due for the taxpayer;
paying the income tax due for the taxpayer and the amount of the plurality of other taxes due for the taxpayer to the appropriate authorities;
paying any net income remaining in the income tax account to the taxpayer;
creating a income tax return for the taxpayer and defining a final tax amount;
determining the final tax amount to be either a tax refund or a tax payment and further comprising the following steps;
(g) if a tax refund,
(i) requesting the appropriate authorities to pay the tax refund to the income tax account;
(ii) paying the tax refund from the income tax account to the taxpayer;
(h) if a tax payment,
(i) paying the tax payment from the income tax account to the appropriate authorities.
